(19) United States
(12) Patent Application Publication
(10) Pub. No.: US 2025/0347172 A1
(43) Pub. Date: Nov. 13, 2025

(54) ROLLING STRUCTURE AND ROLLER BLIND UTILIZING THE ROLLING STRUCTURE

(71) Applicant: QINGYUAN WINDOWSHINE SMART WINDOW COVERING COMPANY LIMITED, QINGYUAN (CN)

(72) Inventors: Weicheng CHEN, QINGYUAN (CN); Jingtao ZHANG, QINGYUAN (CN)

(73) Assignee: QINGYUAN WINDOWSHINE SMART WINDOW COVERING COMPANY LIMITED, QINGYUAN (CN)

(21) Appl. No.: 18/776,653

(22) Filed: Jul. 18, 2024

(30) Foreign Application Priority Data
May 13, 2024 (CN) 2024105900289

(51) Int. Cl. E06B 9/44

(52) U.S. Cl. CPC E06B 9/44

(57) ABSTRACT

The present invention provides a winding structure and a roller blind utilizing the winding structure, comprising a control head, an elastic module group and a stabilizer connected sequentially along a same axis; the elastic module group is configured to provide main winding elastic force for a roller blind; the control head is configured to adjust and strengthen rolling elastic force of the elastic module group; and the stabilizer is configured to provide buffer damping in winding process; the structure is novel and can be adjusted according to practical usage requirements to obtain matching force, which achieves the desired winding effect.

### INCORPORATION BY REFERENCE

This application claims the benefit of priority from China Patent Application No. 2024105900289 filed on May 13, 2024, the contents of which are hereby incorporated by reference in their entirety.

### TECHNICAL FIELD

The present invention relates to the field of roller blinds, and more particularly to a winding structure and a roller blind utilizing the winding structure.

### BACKGROUND ART

At present, there are several styles of roller blind structures available on the market, which are mainly installed in doors and windows of homes and offices to achieve the functions of shielding sunlight and decoration; In current roller blinds, the winding structures that provide power mostly adopt springs to apply force and are utilized as the power components for winding; However, the springs adopted are mostly of uniform specifications, which leads to a problem of power mismatch for some roller blinds in different sizes (such as the same width and different lengths or the same length but different widths), which may affect the normal winding; Moreover, the current winding structures are mostly determined by spring specifications before installation, and after completing the installation, it is unable to make secondary adjustment according to the practical situation, which is inconvenient for utilization and operation and needs to be improved.

### SUMMARY OF THE INVENTION

In order to overcome the defects of the prior art, a technical problem to be solved by the present invention is to propose a winding structure and a roller blind utilizing the winding structure, whose structure is novel and can be adjusted according to practical usage requirements to obtain matching force, which achieves the desired winding effect.

To achieve the purpose, the present invention adopts the following technical solutions:

The present invention provides a winding structure and a roller blind utilizing the winding structure, comprising a control head, an elastic module group and a stabilizer connected sequentially along a same axis; the elastic module group is configured to provide main winding elastic force for a roller blind; the control head is configured to adjust and strengthen rolling elastic force of the elastic module group; and the stabilizer is configured to provide buffer damping in winding process.

In a preferred technical solution of the present invention, the elastic module group comprises at least one elastic module; and the at least one elastic module can be spliced and superposed to change elastic force of the elastic module group.

In a preferred technical solution of the present invention, the at least one elastic module comprises at least one first supporting shaft and at least one coil spring, wherein the at least one first supporting shaft is rotatably arranged on at least one housing, the at least one coil spring is arranged in the at least one housing, an end portion of an inner ring of the at least one coil spring is connected to the at least one first supporting shaft, and an end portion of an outer ring of the at least one coil spring is connected to the at least one housing; and a first drivepipe is fixedly provided at one end of the at least one first supporting shaft, and an inner diameter of the first drivepipe is adapted to a diameter of the at least one first supporting shaft.

In a preferred technical solution of the present invention, second clamping grooves are provided on an outer wall of one end surface of the at least one housing, and second fixture blocks are provided on an outer wall of the other end surface, a shape of the second fixture blocks is matched with that of the clamping grooves, and positions of the second fixture blocks correspond to positions of the second clamping grooves; and two closely adjacent elastic modules are connected and transmitted through the second fixture blocks and the second clamping grooves.

In a preferred technical solution of the present invention, a control head comprises a first sleeve, a supporting sleeve, and a pre-tightening member; the first sleeve is rotatably sleeved on an outer side of the supporting sleeve, a second drivepipe is provided at an end portion of the supporting sleeve, an inner diameter of the second drivepipe is adapted to a diameter of the first supporting shaft, and is configured to connect with the elastic module group; and the pre-tightening member is rotatably inserted in the supporting sleeve, and the pre-tightening member and the supporting sleeve cooperate in unidirectional rotation to tighten and adjust at least one coil spring.

In a preferred technical solution of the present invention, at least one elastic clamping strip is provided at an end portion of the pre-tightening member to serve as a pawl; a precipitation tank is correspondingly provided on an end surface of the supporting sleeve, a plurality of clamping teeth are provided on a tank wall of the precipitation tank, and the plurality of clamping teeth are distributed in a circular array around an axis of the supporting sleeve to serve as a ratchet wheel; and the pre-tightening member and the supporting sleeve cooperate in unidirectional rotation through the at least one elastic clamping strip and the clamping teeth. In a preferred technical solution of the present invention, a stabilizer comprises a second supporting shaft, a torsion spring, and a second sleeve; the second supporting shaft is rotatably arranged on the second sleeve, the torsion spring is sleeved onto the second supporting shaft, the torsion spring is provided in the second sleeve, a clamping strip at an end portion of the torsion spring is clamped on an inner wall of the second sleeve and rotates with the second sleeve, and buffer damping is formed through rotational friction between the torsion spring and the second supporting shaft; and a diameter of an end portion of the second supporting shaft passing through the second sleeve is adapted to a diameter of the first supporting shaft to connect with the elastic module group.

In a preferred technical solution of the present invention, a maximum outer diameter of the second sleeve, a maximum outer diameter of at least one housing, and a maximum outer diameter of a first sleeve are equal, and bayonets that can rotate to a same straight line are arranged thereon.

The present invention further provides a roller blind which comprises the aforementioned winding structure.

The beneficial effects of the present invention are as follows:

The winding structure provided by the present invention, comprising a control head, an elastic module group and a stabilizer connected sequentially along a same axis; the elastic module group is configured to provide main winding elastic force for a roller blind; the control head is configured to adjust and strengthen rolling elastic force of the elastic module group; and the stabilizer is configured to provide buffer damping in winding process; a wide range of elastic force adjustment is achieved through the combination of the elastic module group, and the combination is selected according to requirements to obtain the elastic force close to the target value; the control head is configured to adjust and strengthen the winding elastic force of the elastic module group to achieve secondary adjustment; combined with the friction damping provided by the stabilizer, a combination of multiple forces is achieved, so that the overall winding force can better match the corresponding winding requirements, which effectively expands the scope of application;

[symbol]

The present invention provides a roller blind utilizing the aforementioned winding structure, which can be combined and adjusted according to practical usage requirements to obtain matching force, which achieves the desired winding effect.

### DESCRIPTION OF DRAWINGS

FIG. 1 is a perspective structural diagram of a winding structure provided in a specific embodiment of the present invention;

FIG. 2 is a perspective expansion structural diagram of the winding structure provided in the specific embodiment of the present invention;

FIG. 3 is a perspective structural diagram of an elastic module group provided in the specific embodiment of the present invention;

FIG. 4 is a perspective structural diagram of an elastic module provided in the specific embodiment of the present invention;

FIG. 5 is a perspective expansion structural diagram of the elastic module provided in the specific embodiment of the present invention;

FIG. 6 is a perspective structural diagram of a first supporting shaft provided in the specific embodiment of the present invention;

FIG. 7 is a perspective structural diagram of a housing provided in the specific embodiment of the present invention;

FIG. 8 is a perspective structural diagram of a casing provided in the specific embodiment of the present invention;

FIG. 9 is a perspective structural diagram of a control head provided in the specific embodiment of the present invention;

FIG. 10 is a perspective expansion structural diagram of the control head provided in the specific embodiment of the present invention;

FIG. 11 is a cross-sectional diagram of the control head provided in the specific embodiment of the present invention;

FIG. 12 is a perspective structural diagram of a pre-tightening member provided in the specific embodiment of the present invention;

FIG. 13 is a perspective structural diagram of a supporting sleeve provided in the specific embodiment of the present invention from a first perspective;

FIG. 14 is perspective structural diagram of the supporting sleeve provided in the specific embodiment of the present invention from a second perspective;

FIG. 15 is a perspective structural diagram of a first sleeve provided in the specific embodiment of the present invention;

FIG. 16 is a perspective structural diagram of a stabilizer provided in the specific embodiment of the present invention;

FIG. 17 is a perspective expansion structural diagram of the stabilizer provided in the specific embodiment of the present invention;

FIG. 18 is a perspective structural diagram of a second sleeve provided in the specific embodiment of the present invention; and

FIG. 19 is a perspective structural diagram of a second supporting shaft provided in the specific embodiment of the present invention.

In the drawings:
100—elastic module group; 200—elastic module; 300—first supporting shaft; 310—first clamping groove; 320—clamping head; 330—first drivepipe; 400—coil spring; 500—housing; 510—first bayonet; 520—second bayonet; 530—casing; 531—insertion column; 532—second fixture block; 540—housing cover; 541—notch; 543—second clamping groove;
600—control head; 610—first sleeve; 611—first clamping plate; 612—clamping ring; 620—supporting sleeve; 621—second drivepipe; 622—precipitation tank; 623—clamping tooth; 624—supporting ring; 625—annular groove; 626—arc-shaped protrusion; 627—insertion slot; 630—pre-tightening member; 631—elastic clamping strip; 632—insert strip; 633—convex column; 634—guide hole; 635—through hole; 640—first bearing; 650—inserting rod; 651—guide groove; 660—spring; 670—clamping bead; 700—stabilizer; 710—second supporting shaft; 711—limiting ring; 712—convex ring; 720—torsion spring; 721—clamping strip; 730—second sleeve; 731—second clamping plate; 732—embedding groove; 733—strengthening ring; and 740—third clamping spring.

### Embodiments

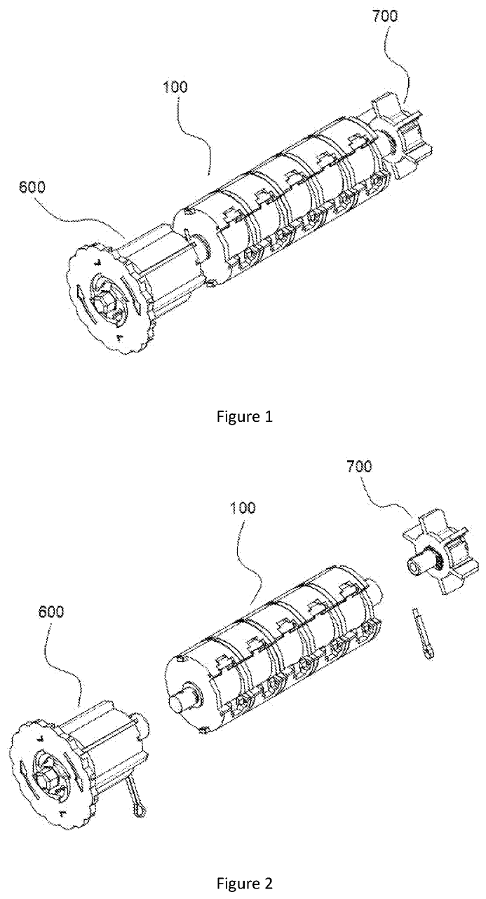

Hereinafter, the technical solutions of the present invention will be further described with reference to the accompanying drawings and through specific embodiments. As shown in FIG. 1 and FIG. 2, a specific embodiment of the present invention discloses a winding structure, comprising a control head 600, an elastic module group 100 and a stabilizer 700 connected sequentially along a same axis; the elastic module group 100 is configured to provide main winding elastic force for a roller blind; the control head 600 is configured to adjust and strengthen rolling elastic force of the elastic module group; and the stabilizer 700 is configured to provide buffer damping in winding process; a wide range of elastic force adjustment is achieved through the combination of the elastic module group, and the combination is selected according to requirements to obtain the elastic force close to the target value; the control head is configured to adjust and strengthen the winding elastic force of the elastic module group to achieve secondary adjustment; combined with the friction damping provided by the stabilizer, a combination of multiple forces is achieved, so that the overall winding force can better match the corresponding winding requirements, which effectively expands the scope of application.

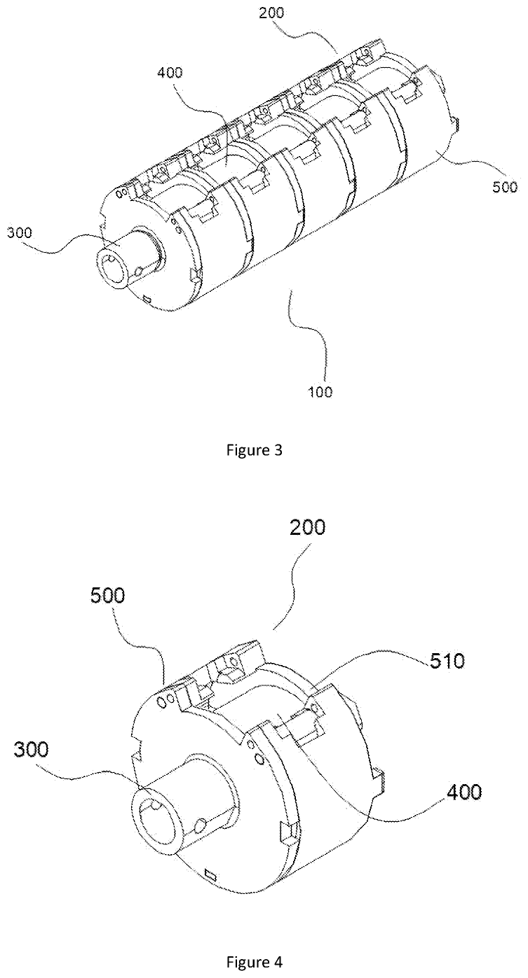

Further, as shown in FIG. 3 and FIG. 4, the elastic module group 100 comprises at least one elastic module 200; and the at least one elastic module can be spliced and superposed to change elastic force of the elastic module group; an appropriate number of elastic modules are chosen and are combined according to the required winding force, so that the elastic force formed by the combination is close to the required elastic force value, and a large range of adjustment is performed, and then a secondary adjustment is performed through the control head, and the stabilizer is damped and buffered in a small range to meet a better winding effect.

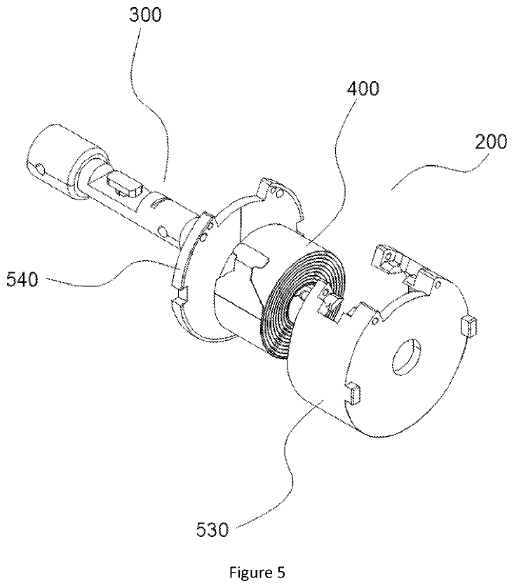

Further, as shown in FIG. 4 and FIG. 5, the at least one elastic module 200 comprises at least one first supporting shaft 300 and at least one coil spring 400, wherein the at least one first supporting shaft 300 is rotatably arranged on at least one housing 500, the at least one coil spring 400 is arranged in the at least one housing 500, an end portion of an inner ring of the at least one coil spring 400 is connected to the at least one first supporting shaft 300, and an end portion of an outer ring of the at least one coil spring 400 is connected to the at least one housing 500; and a first drivepipe 330 is fixedly provided at one end of the at least one first supporting shaft 300, and an inner diameter of the first drivepipe 330 is adapted to a diameter of the at least one first supporting shaft 300; first pin holes are provided on a side wall of the first drivepipe, second pin holes are correspondingly provided at the other end of the at least one first supporting shaft, when the two elastic module groups cooperate, the at least one first supporting shaft can be inserted and can cooperate with the first drivepipe, and the two elastic modules can be fixed by screws/bolts passing through the first pin holes and the second pin holes, which achieves the combination and connection between the two elastic modules, and achieves the superposition of the elastic forces between the two elastic modules.

Further, the at least one housing 500 comprises a casing 530 with one side open, and a housing cover 540 is provided on an outer side of an opening of the casing 530; through holes are correspondingly provided in a center of the casing and the housing cover, the at least one first supporting shaft movably penetrates the casing and the housing cover through the through holes, one end of the at least one first supporting shaft away from the first drivepipe is limited by a first clamping spring, so that the at least one first supporting shaft can rotatably pass through on the casing and the housing cover, and the housing cover is maintained to be closed on the casing to effectively limit the at least one coil spring; an insertion column 531 is fixedly provided on the outer side of the opening of the casing 530, and a socket is correspondingly provided on the housing cover; the housing cover is arranged on the outer side of the opening of the casing and the insertion column is correspondingly inserted into the socket, which can facilitate the alignment and installation between the housing cover and the casing, and synchronous rotation can be performed; and the overall structure adopts an assembled structure, which can facilitate the processing and production of various structural components, and also facilitate the assembly.

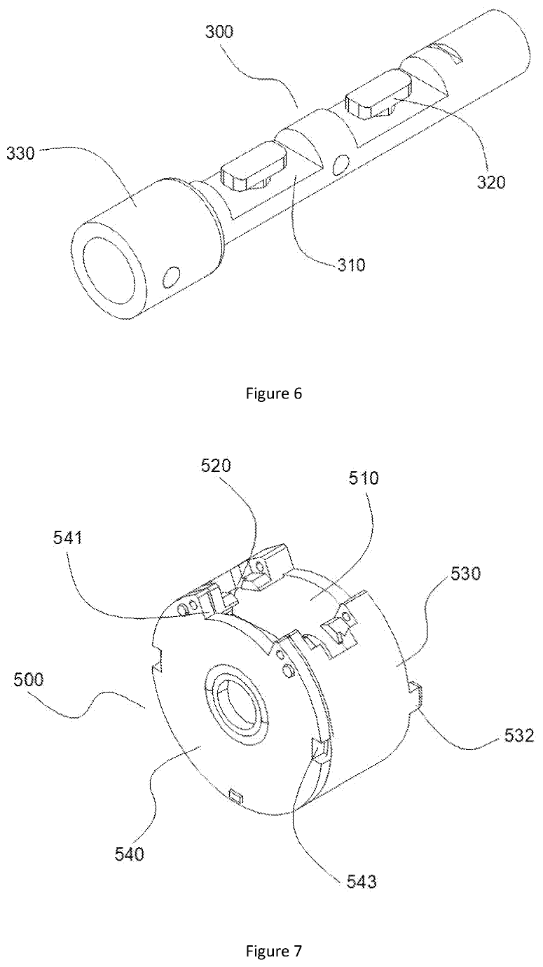

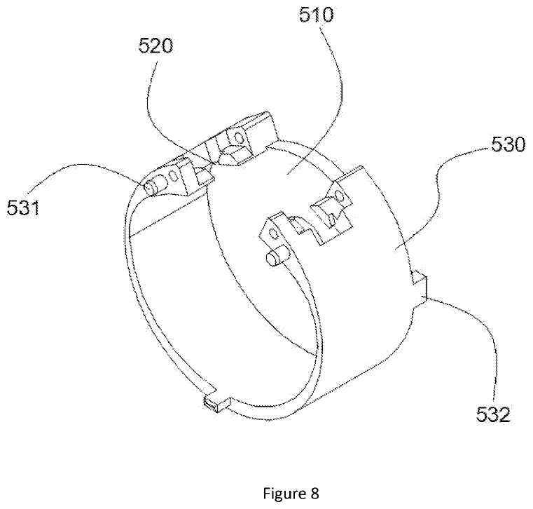

Further, as shown in FIGS. 5 to 8, at least one first clamping groove 310 is provided on an outer side of the at least one first supporting shaft 300, at least one clamping head 320 is fixedly provided at a bottom portion of the first clamping groove 310, and one end of the at least one coil spring 400 is sleeved onto an outer side of the at least one clamping head 320; at least one first bayonet 510 is provided on an outer side of the casing 530, at least one second bayonet 520 is provided on one side of the at least one first bayonet 510, and a clamping piece is fixedly provided on the other end of the at least one coil spring 400, the clamping piece can be extended from the at least one second bayonet and clamped on the outer side of the at least one second bayonet, which further limits the other end of the at least one coil spring, so that both ends of the at least one coil spring are respectively connected and cooperate with the at least one first supporting shaft and the at least one housing, so that the at least one coil spring is rolled up in the at least one housing, and the outer side of the at least one coil spring is limited by the at least one housing to maintain the winding state, which is convenient to provide the subsequently required elastic force; moreover, at least one notch 541 is provided on an edge of the housing cover 540, and a position of the at least one notch 541 corresponds to a position of the at least one first bayonet 510, to form a continuous bayonet portion, which facilitates the engaged cooperation with inside of the roller blind rod, and meets the required assembly effect.

Further, second clamping grooves 543 are provided on an outer wall of one end surface of the at least one housing 500, and second fixture blocks 532 are provided on an outer wall of the other end surface, a shape of the second fixture blocks 532 is matched with that of the clamping grooves 543, and positions of the second fixture blocks correspond to positions of the second clamping grooves; and two closely adjacent elastic modules are connected and transmitted through the second fixture blocks and the second clamping grooves; wherein, the second clamping grooves are provided at an edge of the housing cover, and the at least one second bayonet is provided at an edge of a wall of the casing away from the opening, so that the clamping and cooperation can be performed between the at least one housing after assembly to achieve synchronous movement; the present structural design is mainly for the structure of the elastic module of multiple coil springs, when the length of the first supporting shaft is long enough to be able to sleeve onto more than two coil springs, it means that there are two housings, and the two housings can cooperate through the second fixture blocks and the second clamping grooves, can move synchronously, and provide greater winding force; it should be noted that the length of the first supporting shaft can be preset in advance for several commonly used specifications, including but not limited to being able to be wound with one/two/three coil springs, which can be chosen and combined accordingly according to practical requirements to meet different elastic requirements.

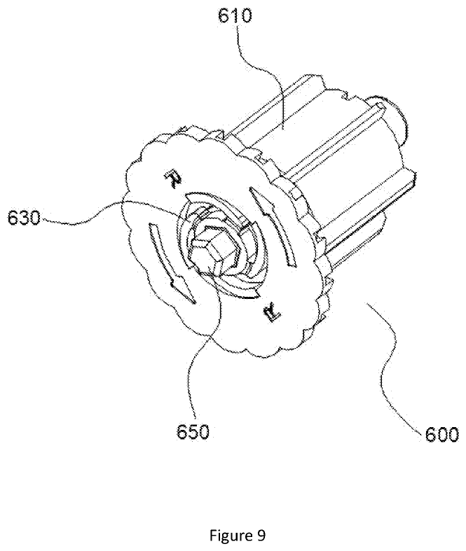

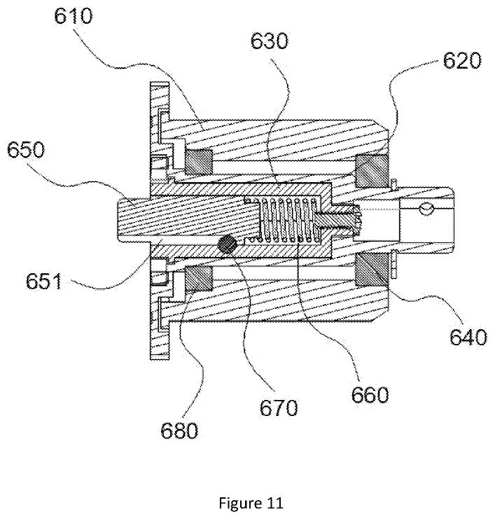

Further, as shown in FIGS. 9 to 14, a control head 600 comprises a first sleeve 610, a supporting sleeve 620, and a pre-tightening member 630; the first sleeve 610 is rotatably sleeved on an outer side of the supporting sleeve 620, a second drivepipe 621 is provided at an end portion of the supporting sleeve 620, an inner diameter of the second drivepipe 621 is adapted to a diameter of the first supporting shaft 300, and is configured to connect with the elastic module group; and the pre-tightening member 630 is rotatably inserted in the supporting sleeve 620, and the pre-tightening member 630 and the supporting sleeve 620 cooperate in unidirectional rotation to tighten and adjust at least one coil spring 400; third pin holes are correspondingly provided on an outer wall of the second drivepipe, when the control head and the elastic module group are assembled, it is necessary to insert an end portion of the at least one first supporting shaft into the second drivepipe and connect them by screws/pins to connect both for transmission; the pre-tightening member and the supporting sleeve cooperate in unidirectional rotation to pre-tighten and adjust the elastic assembly, and it can also be rotated and adjusted when assembled on wall installation codes, and the spring module group is adjusted twice to meet the required elastic force requirements.

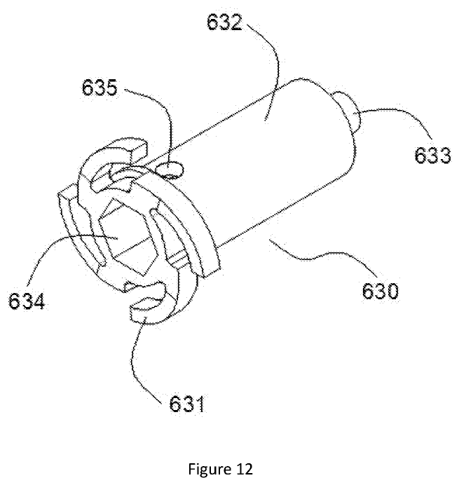

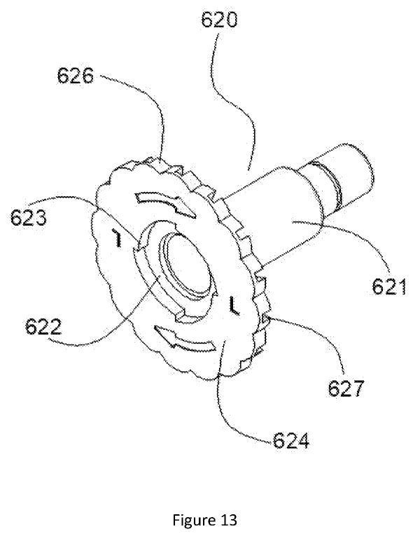

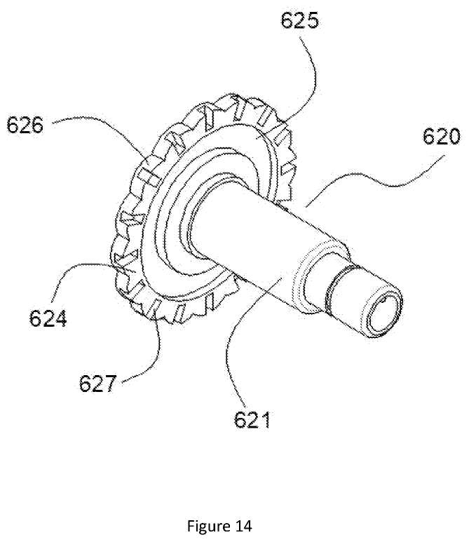

Further, as shown in FIG. 12 and FIG. 13, at least one elastic clamping strip 631 is provided at an end portion of the pre-tightening member 630 to serve as a pawl; a precipitation tank 622 is correspondingly provided on an end surface of the supporting sleeve 620, a plurality of clamping teeth 623 are provided on a tank wall of the precipitation tank 622, and the plurality of clamping teeth are distributed in a circular array around an axis of the supporting sleeve to serve as a ratchet wheel; and the pre-tightening member and the supporting sleeve cooperate in unidirectional rotation through the at least one elastic clamping strip and the clamping teeth.

Further, as shown in FIG. 12, the pre-tightening member 630 comprises an insert strip 632, a diameter of the insert strip 632 is adapted to an inner diameter of the supporting sleeve 620, a convex column 633 is fixedly provided at a center of an end portion of the insert strip 632, a diameter of the convex column 633 is smaller than the diameter of the insert strip, a first circular hole is correspondingly provided at an end portion of the supporting sleeve, a diameter of the first circular hole is adapted to the diameter of the convex column, and a threaded hole is provided at a center of the convex column for installing the screw; the insert strip is maintained inserted in a portion of the supporting sleeve by the screw, and the at least one elastic clamping strip is arranged in the precipitation tank to maintain the required cooperation of unidirectional rotation;

[symbol]

Further, the at least one elastic clamping strip 631 is fixedly provided on a side wall of the end portion of the insert strip 632, the number of the at least one elastic clamping strip 631 is preferably to be four, and the four elastic clamping strips 631 are distributed in a circular array around an axis of the insert strip 632. Although the number of the at least one elastic clamping strip is increased, the at least one elastic clamping strip can still be squeezed normally during rotation, so that the pre-tightening member can rotate normally; in addition, multi-point positioning cooperation can be formed between a plurality of elastic clamping strips and the clamping teeth, which enhances the directional locking force and effectively prevents the pre-tightening member from rotating in a opposite direction;

[symbol]

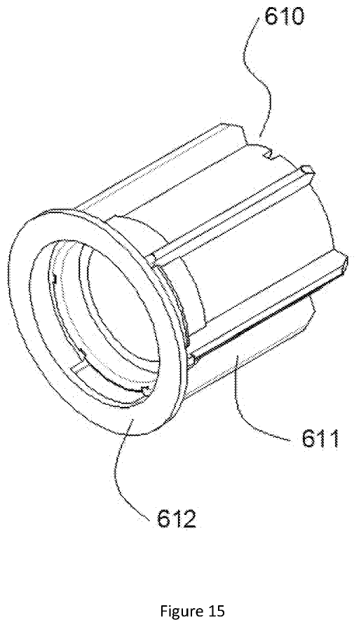

Further, as shown in FIG. 13 and FIG. 14, a supporting ring 624 is fixedly provided on an outer wall of one end portion of the supporting sleeve 620 close to the precipitation tank, an outer diameter of the supporting ring 624 is larger than an inner diameter of the first sleeve 610, and the end portion of the first sleeve slides against a wall surface of the supporting ring; a first bearing 640 is arranged on the second drivepipe 621, an outer ring diameter of the first bearing is adapted to the inner diameter of the end portion of the first sleeve, and an outer ring of the first bearing is tightly clamped at a port of the first sleeve, so that the first sleeve is rotatably sleeved onto the outer side of the supporting sleeve; as shown in FIG. 15, a plurality of first clamping plates 611 are fixedly provided on the outer wall of the first sleeve 610, and the plurality of first clamping plates 611 are distributed in a circular array around the axis of the first sleeve 610, an outer wall surface of each of the first clamping plates is in an arc-shaped structure, and a distance from the outer wall surface of the first clamping plates to the axis of the first sleeve is equal to a radius of the casing, and a third bayonet is formed between the two adjacent first clamping plates, and a width of the third bayonet is adapted to that of the at least one first bayonet, so that it can be smoothly inserted into the inside of the roller blind rod and perform the required engaged cooperation;

[symbol]

Further, the diameter of the supporting sleeve is larger than that of the second drivepipe, a first step portion is formed, a second step portion is arranged on an inner wall of the port of the first sleeve, the second step portion is flush with the first step portion, at least one third clamping groove is provided on an outer wall of the second drivepipe for clamping the second clamping spring, so that the first bearing is provided between the second clamping spring and the first step portion and the second step portion, and the first sleeve is blocked by the first bearing; a pressure ring is provided at a joint between the supporting sleeve and the supporting ring, and a third step portion is provided on the inner wall of the end portion of the first sleeve close to the supporting ring, an inner diameter of the third step portion is adapted to an outer diameter of the second bearing, an inner diameter of the second bearing is adapted to an outer diameter of the supporting sleeve, the second bearing is sleeved onto the outer side of the supporting sleeve, the outer ring of the second bearing is clamped at the port of the first sleeve, and the second bearing is clamped between the third step portion and the pressure ring;

[symbol]

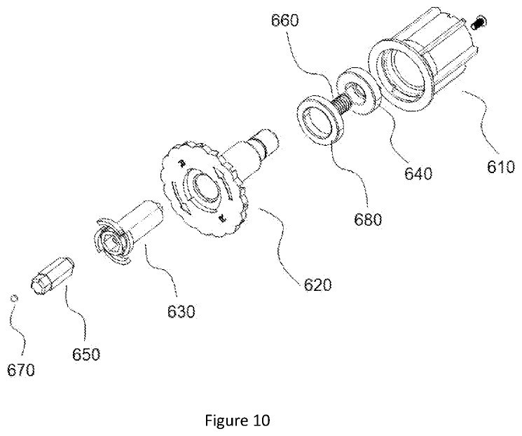

Further, as shown in FIGS. 10 to 12, a guide hole 634 is arranged on the insert strip 632 along the axial direction, and an end of the guide hole away from the convex column is open, and an inserting rod 650 is inserted and provided in a position of the guide hole 634, and a spring 660 is provided in the guide hole 634 to provide an elastic force for the inserting rod 650 to push outward, but the inserting rod will not be separated from a position of the guide hole, so that it has a telescopic function, so that the control head can be assembled with external installation codes, and facilitates disassembly and assembly;

[symbol]

Further, a guide groove 651 is provided on an outer wall of the inserting rod 650, one end of the guide groove 651 away from one end of the spring 660 extends to an end surface of the inserting rod 650; at least one through hole 635 is provided on a side wall of one end of the insert strip 632 close to the at least one elastic clamping strip 631, the at least one through hole communicates with the guide hole and corresponds to a position of the guide groove, a clamping bead 670 is provided at a position of the at least one through hole 635, a bottom of the guide groove is in an arc-shaped structure, which is adapted to the clamping bead, the inserting rod 650 moves along the guide hole 634 and is prevented from falling off by the clamping bead 670; the overall structure adopts an assembled structure, which can facilitate the processing and production of various structural components, and also facilitate the assembly.

Further, the inserting rod is in a prismatic strip structure, and the shape of the guide hole is adapted to the shape of the inserting rod, which can effectively prevent the inserting rod from rotating, and also facilitates alignment installation, so that the clamping bead and the guide groove are aligned and cooperate, which also facilitates the cooperation between the inserting rod with the external installation codes;

[symbol]

Further, as shown in FIG. 14, an annular groove 625 is provided on a wall surface of the supporting ring 624 close to the first sleeve 610, and a clamping ring 612 is correspondingly provided on the end surface of the first sleeve 610, a position of the clamping ring corresponds to a position of the annular groove, and the shape is adapted, the clamping ring rotates and abuts against a bottom of the annular groove, a contact area between the first sleeve and the supporting ring is further increased by providing the clamping ring and the annular groove, which can strengthen the overall cooperation; in addition, the structure can further facilitate the alignment and assembly between the first sleeve and the supporting sleeve;

[symbol]

Further, chamfers are provided on an outer ring of end portions of the first clamping plates away from the supporting ring, that the outer ring profile of an insertion end of the control head can be reduced, which is convenient for the control head to be smoothly inserted into the roller blind rod, and facilitates the installation;

[symbol]

Further, a plurality of arc-shaped protrusions 626 are provided on an outer wall of the supporting ring 624, wherein the plurality of arc-shaped protrusions are distributed in a circular array around an axis of the supporting ring, and ends of the two adjacent arc-shaped protrusions are connected, which has an anti-slip effect, so as to grasp the supporting ring for adjustment;

[symbol]

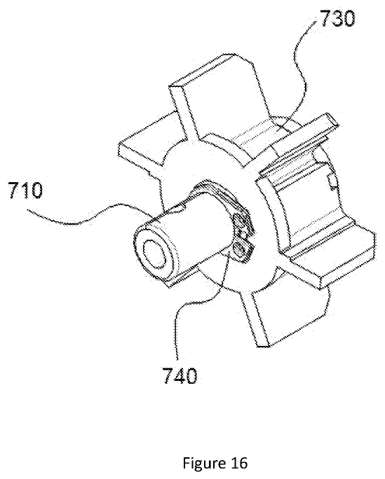

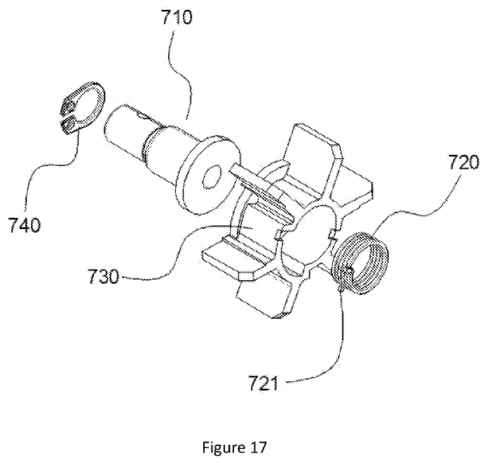

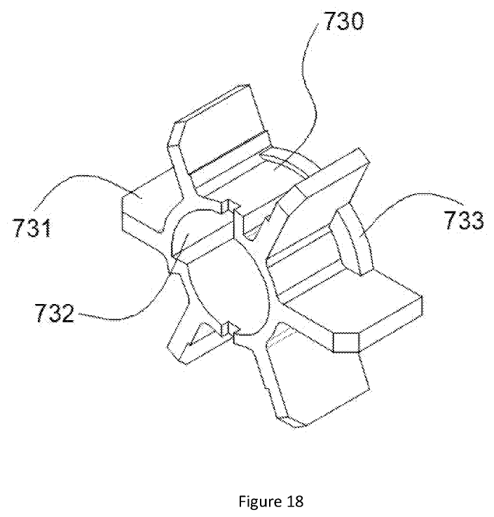

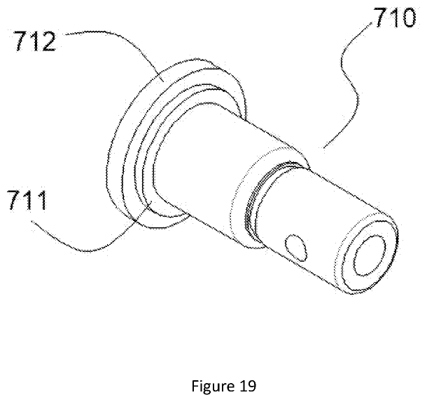

Further, insertion slots 627 extending in the radial direction are provided at the arc-shaped protrusions 626, and the supporting ring can be adjusted by inserting a screwdriver or other structural tools, which is applicable to the operation after completing the installation when it is inconvenient to grip the supporting ring. Further, as shown in FIGS. 16 to 19, a stabilizer 700 comprises a second supporting shaft 710, a torsion spring 720, and a second sleeve 730; the second supporting shaft 710 is rotatably arranged on the second sleeve 730, the torsion spring 720 is sleeved onto the second supporting shaft 710, the torsion spring 720 is provided in the second sleeve 730, a clamping strip 721 at an end portion of the torsion spring 720 is clamped on the inner wall of the second sleeve 730 and rotates with the second sleeve, and buffer damping is formed through rotational friction between the torsion spring and the second supporting shaft; and a diameter of the end portion of the second supporting shaft 710 passing through the second sleeve is adapted to a diameter of the first supporting shaft 300 to connect with the elastic module group; Fourth pin holes are correspondingly provided on a side wall of the end portion of the second supporting shaft, when the stabilizer and the elastic module group are assembled, the end portion of the second supporting shaft is inserted into the first drivepipe and is connected by screws/pins to connect the two for transmission; a plurality of second clamping plates 731 are fixedly provided on the outer wall of the second sleeve 730, the plurality of second clamping plates 731 are arranged in a circular array around the axis of the second sleeve 730, and a fourth clamping port is formed between the two adjacent second clamping plates, and the width of the fourth clamping port is adapted to a width of the first clamping port so that it can be smoothly inserted into the roller blind rod and can perform the required engaged cooperation; at least one embedding groove 732 is provided on the inner wall of the second sleeve 730 corresponding to a clamping strip at the end of the torsion spring 720, the clamping strip 721 at the end portion of the torsion spring 720 is clamped in the at least one embedding groove 732, which makes the torsion spring and the second sleeve move synchronously, so that the friction between the torsion spring and the second supporting shaft plays a corresponding damping effect; and the overall structure adopts an assembled structure, which facilitates the processing and production of various structural components, and also facilitates the disassembly and replacement of components and parts; the overall structure of the stabilizer is simple, and the buffer damping is formed through rotational friction between the torsion spring and the second supporting shaft, which is arranged to overcome the elastic force error of the roller blind and plays the required buffering and balancing effects.

Further, a cross section of the at least one embedding groove 732 is in a fan-shaped structure, and the clamping strips 721 at both ends of the torsion spring 720 fall into a same embedding groove 732, and the clamping strips are blocked by a groove wall of the at least one embedding groove, so that the torsion spring moves with the second sleeve; a single embedding groove with a larger range can further facilitate the installation of the torsion spring, and the assembly can be completed without fine alignment;

[symbol]

Further, a limiting ring 711 is fixedly provided at the end portion of the second supporting shaft 710 away from the fourth pin holes, and a convex ring 712 is provided on a side wall of an end portion of the limiting ring 711, a diameter of the limiting ring 711 is adapted to an inner diameter of the second sleeve 730, and a fourth clamping groove is further provided on an outer wall of the second supporting shaft 710 for clamping the third clamping spring 740; a second circular hole is provided at an end portion of the second sleeve, the second supporting shaft passes through the second sleeve through the second circular hole, the limiting ring is rotatably arranged in a port of the second sleeve, and the convex ring abuts against an outer side of the port of the second sleeve, and the third clamping spring abuts against an outer side of a port of the second circular hole, so that the second supporting shaft is rotatably arranged at the second sleeve, and the torsion spring is sleeved onto the second supporting shaft in the second sleeve; and an assembled structure is utilized, which can facilitate the processing and production of various structural components, and also facilitate the assembly;

[symbol]

Further, a strengthening ring 733 is fixedly provided on an outer wall of the end portion of the second sleeve 730 away from the opening, and end portions of the second clamping plates 731 are fixedly connected with the strengthening ring 733, which is for strengthening the support for the second clamping plates, enhancing the overall structural strength, and preventing the second clamping plates from being broken or damaged;

[symbol]

Further, chamfers are provided on an outer ring of the end portions of the second clamping plates close to the opening, so that the outer ring profile of the insertion end can be reduced, which is convenient for the stabilizer to be smoothly inserted into the roller blind rod, and facilitates the installation;

[symbol]

Further, a maximum outer diameter of the second sleeve, a maximum outer diameter of at least one housing, and a maximum outer diameter of a first sleeve are equal, and bayonets that can rotate to a same straight line are arranged thereon; wherein, the at least one first bayonet is arranged on the outer wall of the casing, the at least one notch is correspondingly provided on the housing cover, the third bayonet is arranged on an outer side of the first sleeve, and the fourth bayonet is arranged on an outer side of the second sleeve; during installation, the stabilizer, the elastic module group, and the control head are inserted from a port of the roller blind rod sequentially, so that the fourth bayonet, the first bayonet and the notch, and the third bayonet sequentially correspond to the convex strip in the roller blind rod, which makes the roller blind rod and the second sleeve, the at least one housing, and the second sleeve move synchronously, and further utilizes the winding elastic force of the internal coil spring and the friction damping between the torsion spring and the second supporting shaft to achieve the desired winding effect and balancing effect.

The present invention further discloses a roller blind, comprising installation codes, a supporting end, a roller blind rod, curtain cloth, and the aforementioned winding structure; it can be combined and adjusted according to practical usage requirements to obtain matching force, which achieves the desired winding effect; wherein, the installation codes are installed on the wall, the winding structure is installed on the roller blind rod, the supporting end is installed on the other end of the roller blind rod, the roller blind rod is framed between the two installation codes through the control head and the supporting end, and the curtain cloth is wound and installed on the roller blind rod; the aforementioned installation codes, the supporting end, the roller blind rod, and the curtain cloth are all common in the field of roller blinds, and more specific structures and connection and installation methods will not be repeated.

The present invention is described by preferred embodiments, and those skilled in the art shall appreciate that various changes or equivalent substitutions may be made to these features and embodiments without departing from the spirit and scope of the present invention. The present invention is not limited to the specific embodiments disclosed herein, and other embodiments falling within the claims of the present application shall fall within the protection scope of the present invention.

1. A winding structure, wherein:
comprising a control head, an elastic module group and a stabilizer connected sequentially along a same axis;
the elastic module group is configured to provide main winding elastic force for a roller blind;
the control head is configured to adjust and strengthen rolling elastic force of the elastic module group; and
the stabilizer is configured to provide buffer damping in winding process.

2. The winding structure according to claim 1, wherein:
the elastic module group comprises at least one elastic module; and
the at least one elastic module can be spliced and superposed to change elastic force of the elastic module group.

3. The winding structure according to claim 2, wherein:
the at least one elastic module comprises at least one first supporting shaft and at least one coil spring, wherein the at least one first supporting shaft is rotatably arranged on at least one housing, the at least one coil spring is arranged in the at least one housing, an end portion of an inner ring of the at least one coil spring is connected to the at least one first supporting shaft, and an end portion of an outer ring of the at least one coil spring is connected to the at least one housing; and
a first drivepipe is fixedly provided at one end of the at least one first supporting shaft, and an inner diameter of the first drivepipe is adapted to a diameter of the at least one first supporting shaft.

4. The winding structure according to claim 3, wherein:
second clamping grooves are provided on an outer wall of one end surface of the at least one housing, and second fixture blocks are provided on an outer wall of the other end surface, a shape of the second fixture blocks is matched with that of the clamping grooves, and positions of the second fixture blocks correspond to positions of the second clamping grooves; and
two closely adjacent elastic modules are connected and transmitted through the second fixture blocks and the second clamping grooves.

5. The winding structure according to claim 4, wherein:
a control head comprises a first sleeve, a supporting sleeve, and a pre-tightening member;
the first sleeve is rotatably sleeved on an outer side of the supporting sleeve, a second drivepipe is provided at an end portion of the supporting sleeve, an inner diameter of the second drivepipe is adapted to a diameter of the first supporting shaft, and is configured to connect with the elastic module group; and
the pre-tightening member is rotatably inserted in the supporting sleeve, and the pre-tightening member and the supporting sleeve cooperate in unidirectional rotation to tighten and adjust at least one coil spring.

6. The winding structure according to claim 5, wherein:
at least one elastic clamping strip is provided at an end portion of the pre-tightening member to serve as a pawl;
a precipitation tank is correspondingly provided on an end surface of the supporting sleeve, a plurality of clamping teeth are provided on a tank wall of the precipitation tank, and the plurality of clamping teeth are distributed in a circular array around an axis of the supporting sleeve to serve as a ratchet wheel; and
the pre-tightening member and the supporting sleeve cooperate in unidirectional rotation through the at least one elastic clamping strip and the clamping teeth.

7. The winding structure according to claim 6, wherein:
a stabilizer comprises a second supporting shaft, a torsion spring, and a second sleeve;
the second supporting shaft is rotatably arranged on the second sleeve, the torsion spring is sleeved onto the second supporting shaft, the torsion spring is provided in the second sleeve, a clamping strip at an end portion of the torsion spring is clamped on an inner wall of the second sleeve and rotates with the second sleeve, and buffer damping is formed through rotational friction between the torsion spring and the second supporting shaft; and
a diameter of an end portion of the second supporting shaft passing through the second sleeve is adapted to a diameter of the first supporting shaft to connect with the elastic module group.

8. The winding structure according to claim 7, wherein:
a maximum outer diameter of the second sleeve, a maximum outer diameter of at least one housing, and a maximum outer diameter of a first sleeve are equal, and bayonets that can rotate to a same straight line are arranged thereon.

9. A roller blind, wherein:
comprising the winding structure according to claim 8.
